(19) United States
(12) Patent Application Publication
(10) Pub. No.: US 2026/0301570 A1
(43) Pub. Date: Oct. 1, 2026

(54) PUBLIC TRANSPORTATION MANAGING SYSTEM AND METHOD THEREOF

(71) Applicant: EXCELLENCE OPTOELECTRONICS INC., Miaoli County (TW)

(72) Inventors: Kuo-Hsin HUANG, Miaoli County (TW); Fang-Yue HUANG, Miaoli County (TW); Sheng-Hua YANG, Miaoli County (TW)

(21) Appl. No.: 19/577,340

(22) Filed: Mar. 24, 2026

Related U.S. Application Data
(60) Provisional application No. 63/776,996, filed on Mar. 25, 2025.

(30) Foreign Application Priority Data
Jan. 26, 2026 (TW) 115102980

(51) Int. Cl. G08G 1/127; B60W 60/00

(52) U.S. Cl. CPC G08G 1/127; B60W 60/00; B60W 2556/45

(57) ABSTRACT

A public transportation managing system includes a plurality of roadside units. Each of the roadside units includes a roadside controller, a roadside sensor and a roadside communication module. Each of the roadside controllers includes a roadside processor and a roadside storage medium, and each of the roadside storage mediums is configured to store a roadside management module. Based on the roadside management modules, the roadside controllers are configured to: generate a predicted situation for a roadside area based on roadside sensing information; generate a broadcast message of a broadcast time point based on the predicted situation and a priority label or a timeliness label thereof; and transmit the broadcast message to a plurality of vehicles at the broadcast time point.

### RELATED APPLICATIONS

This application claims priority to U.S. Provisional Application Ser. No. 63/776,996, filed Mar. 25, 2025, and Taiwan Application Serial Number 115102980, filed Jan. 26, 2026, which are herein incorporated by reference.

### BACKGROUND

### Technical Field

The present disclosure relates to a public transportation managing system and method thereof, and particularly to a public transportation managing system employing roadside units and method thereof.

### Description of Related Art

With the development of science and technology, more and more advanced technologies are being applied to the field of public transportation. However, public transportation managing systems and methods thereof in the prior art still have certain shortcomings.

For example, the prior art mostly focuses on single-vehicle control, local demand prediction, or cloud scheduling, lacking global dynamic scheduling capabilities that integrate roadside unit (RSU) edge inference, cloud AI (Artificial Intelligence) reinforcement learning, passenger demand, and V2X (Vehicle-to-everything) real-time communication. Therefore, the prior art is usually unable to respond to traffic events or passenger demand fluctuations within seconds, and also lacks event-triggered communication mechanisms, bandwidth optimization, and in-fleet collaborative control.

Based on the above, in the current market for public transportation managing systems and methods thereof, there is an urgent need for public transportation managing systems and methods thereof that can respond to traffic events or passenger demand fluctuations within seconds, and provide event-triggered communication mechanisms, bandwidth optimization, and in-fleet collaborative control.

### SUMMARY

According to one aspect of the present disclosure, provided is a public transportation managing system including a plurality of roadside units. Each of the roadside units includes a roadside controller, a roadside sensor and a roadside communication module, the roadside controller, the roadside sensor and the roadside communication module of each of the roadside units are communicatively connected, each of the roadside controllers includes a roadside processor and a roadside storage medium, and each of the roadside storage mediums is configured to store a roadside management module. Based on the roadside management modules, the roadside controllers are configured to: obtain a plurality of roadside sensing information of a roadside area at a plurality of time points through the roadside sensors; generate a predicted situation for the roadside area through at least one of the roadside controllers based on the roadside sensing information; generate a priority label or a timeliness label for the predicted situation through the at least one of the roadside controllers; generate a broadcast message of a broadcast time point through the at least one of the roadside controllers based on the predicted situation and the priority label or the timeliness label thereof; and transmit the broadcast message to a plurality of vehicles at the broadcast time point through at least one of the roadside communication modules.

According to another aspect of the present disclosure, provided is a public transportation managing method including: obtaining a plurality of roadside sensing information of a roadside area at a plurality of time points through at least one roadside sensor of at least one roadside unit; generating a predicted situation for the roadside area through at least one roadside controller of the at least one roadside unit based on the roadside sensing information; generating a priority label or a timeliness label for the predicted situation through the at least one roadside controller; generating a broadcast message of a broadcast time point through the at least one roadside controller based on the predicted situation and the priority label or the timeliness label thereof; and transmitting the broadcast message to a plurality of vehicles at the broadcast time point through at least one roadside communication module of the at least one roadside unit.

### BRIEF DESCRIPTION OF THE DRAWINGS

The present disclosure can be more fully understood by reading the following detailed description of the embodiment, with reference made to the accompanying drawings as follows:

FIG. 1A is a block diagram of a public transportation managing system according to a first embodiment of the present disclosure.

FIG. 1B is a schematic diagram illustrating a usage state of the public transportation managing system in FIG. 1A.

FIG. 2 is a flowchart of a public transportation managing method according to a second embodiment of the present disclosure.

### DETAILED DESCRIPTION

Embodiments of the present disclosure will be described below with reference to the drawings. For clarity of explanation, certain practical details are set forth in the following description. However, it should be understood that these practical details are not intended to limit the present disclosure. That is, in the embodiments of the present disclosure, such practical details are not essential. In addition, for the sake of simplifying the diagrams, some commonly known structures and components will be shown in a simple schematic manner, and repeated components may be designated by the same reference numerals.

Furthermore, the terms “first”, “second”, etc., are used merely to describe different components, but do not restrict the components themselves. Therefore, a first component may also be referred to as a second component. Moreover, the combinations of components described herein are not well-known, conventional, or commonly known combinations in the art. Therefore, whether such combination relationships are easily achievable by those of ordinary skill in the art cannot be determined based on whether the components themselves are commonly known.

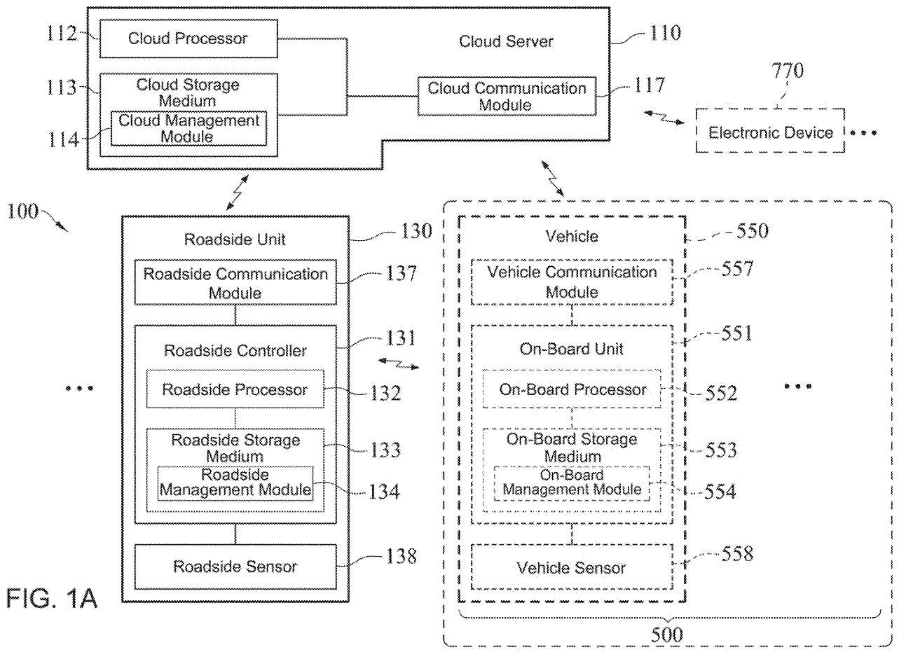

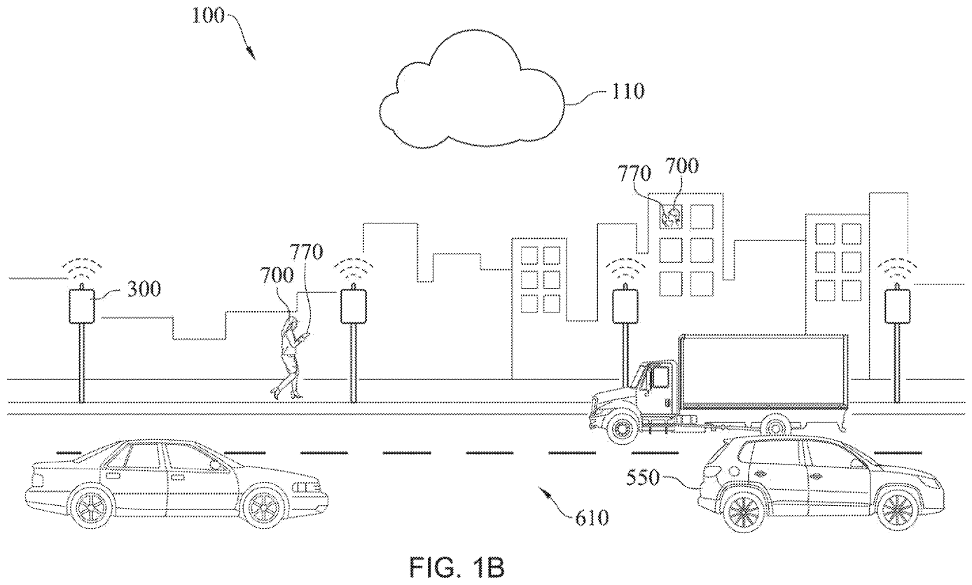

FIG. 1A is a block diagram of a public transportation managing system 100 according to a first embodiment of the present disclosure, and FIG. 1B is a schematic diagram illustrating a usage state of the public transportation managing system 100 in FIG. 1A. Referring to FIGS. 1A and 1B, the public transportation managing system 100 includes a plurality of roadside units 130. Each of the roadside units 130 includes a roadside controller 131, a roadside sensor 138 and a roadside communication module 137. The roadside controller 131, the roadside sensor 138 and the roadside communication module 137 of each of the roadside units 130 are communicatively connected. Each of the roadside controllers 131 includes a roadside processor 132 and a roadside storage medium 133, and each of the roadside storage mediums 133 is configured to store a roadside management module 134. Specifically, each of the roadside storage mediums 133 is a nonvolatile memory, which may also be referred to as a non-transitory computer-readable memory, and each of the roadside management modules 134 is program code. Furthermore, each of the roadside units 130 may include a plurality of roadside sensors 138. The roadside sensors 138 may be cameras, radars, and are not limited thereto.

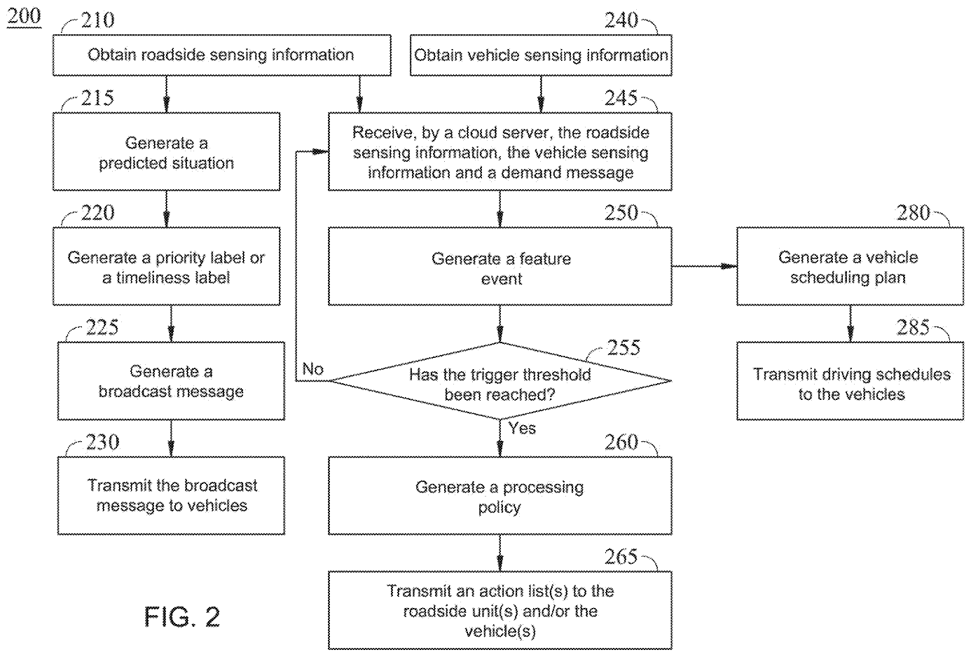

FIG. 2 is a flowchart of a public transportation managing method 200 according to a second embodiment of the present disclosure. With reference to FIGS. 1A, 1B and 2, the public transportation managing method 200 according to the second embodiment of the present disclosure is used to assist in explaining the public transportation managing system 100 according to the first embodiment. It should be understood that the public transportation managing system 100 according to the first embodiment is not limited to implementing the public transportation managing method 200 according to the second embodiment, and the public transportation managing method 200 according to the second embodiment is not limited to being implemented by the public transportation managing system 100 according to the first embodiment.

Based on the roadside management modules 134, the roadside controllers 131 are configured to execute Steps 210, 215, 220, 225, 230 of the public transportation managing method 200. Step 210 includes obtaining a plurality of roadside sensing information of a roadside area 610 at a plurality of time points through (i.e., by) the roadside sensors 138. The roadside sensing information includes information on pedestrians, vehicles 550, and obstacle recognition, and is not limited thereto. Step 215 includes generating a predicted situation (predicted scenario) for the roadside area 610 through at least one of the roadside controllers 131 based on the roadside sensing information. Step 220 includes generating a priority label or a timeliness label for the predicted situation through the at least one of the roadside controllers 131. Step 225 includes generating a broadcast message of a broadcast time point through the at least one of the roadside controllers 131 based on the predicted situation and the priority label or the timeliness label thereof. The broadcast message may include traffic signal phase transition announcements, event triggers, and is not limited thereto. Step 230 includes transmitting the broadcast message to a plurality of vehicles 550 at the broadcast time point through at least one of the roadside communication modules 137. Therefore, by using edge AI in the roadside units 130 to perform real-time environment sensing, event detection, and situation prediction, it helps to further achieve second-level policy execution and closed-loop control, and can reduce communication load through event-triggered broadcasting.

In detail, in Step 215, the public transportation managing system 100 may obtain the predicted situation through a Long Short-Term Memory (LSTM) algorithm in the at least one roadside management module 134 of the at least one of the roadside controllers 131. A time of the predicted situation is calculated from obtaining the roadside sensing information, and the time of the predicted situation may be between 2 seconds and 7 seconds. Therefore, prediction accuracy can be achieved and communication load can be reduced by utilizing the edge AI. Furthermore, the time of the predicted situation may be between 3 seconds and 5 seconds.

A public transportation fleet 500 may include vehicles 550, and each of the vehicles 550 may have an autonomous driving function. Therefore, the public transportation managing system 100 according to the present disclosure can achieve second-level response to traffic events or passenger demand fluctuations, event-triggered communication mechanisms, bandwidth optimization, and in-fleet collaborative control. Furthermore, the vehicles 550 in the public transportation fleet 500 may be motorcycles, passenger cars, buses, trucks, and are not limited thereto. Each of the vehicles 550 includes an on-board unit (OBU) 551, a vehicle sensor 558 and a vehicle communication module 557. The on-board unit 551, the vehicle sensor 558 and the vehicle communication module 557 of each of the vehicles 550 are communicatively connected. Each of the on-board units 551 includes an on-board processor 552 and an on-board storage medium 553, and each of the on-board storage mediums 553 is configured to store an on-board management module 554. Based on the on-board management module 554, the on-board unit 551 can be used to implement the public transportation managing method 200. Specifically, each of the on-board storage mediums 553 is a nonvolatile memory, and each of the on-board management modules 554 is program codes. Furthermore, each of the on-board units 551 may include a plurality of vehicle sensors 558. The vehicle sensors 558 may be cameras, radars, and are not limited thereto.

The public transportation managing system 100 may further include a cloud server 110, which includes a cloud processor 112, a cloud storage medium 113 and a cloud communication module 117. The cloud server 110 is communicatively connected to the roadside units 130 and the vehicles 550. The cloud processor 112, the cloud storage medium 113 and the cloud communication module 117 are communicatively connected. The cloud storage medium 113 is configured to store a cloud management module 114. Specifically, the cloud storage medium 113 is a nonvolatile memory, and the cloud management module 114 is program code and includes a cloud AI module. The cloud communication module 117, the roadside communication modules 137 and the vehicle communication modules 557 all support the V2X communication protocol, which includes message types such as passenger demand, fleet operation commands, traffic event alerts, and vehicle status feedback, thereby facilitating the support of event-triggered message transmission and bandwidth optimization.

Based on the cloud management module 114, the cloud server 110 is configured to execute Steps 240, 245, 250, 255, 260, 265 of the public transportation managing method 200. Step 240 includes obtaining a plurality of vehicle sensing information at the time points through a plurality of respective vehicle sensors 558 of the vehicles 550. Step 245 includes receiving the roadside sensing information, the plurality of vehicle sensing information, and at least one demand message from at least one user 700 transmitted by at least one electronic device 770 through the cloud communication module 117. Specifically, the demand message(s) from the user(s) 700 includes historical travel data, weather, activities, application query traffic, cross-data-source time alignment and feature engineering, and are not limited thereto. Furthermore, Step 245 may further include receiving vehicle speed, acceleration, position, occupancy rate, driving intent, and control status of the vehicles 550 through the cloud communication module 117.

Step 250 includes generating a feature event based on the roadside sensing information, the vehicle sensing information and the at least one demand message, the feature event includes a plurality of features, and the features includes a plurality of safety features. Step 255 includes determining whether any of the features reaches a corresponding trigger threshold. When any of the features reaches the corresponding trigger threshold, Step 260 is executed; when any of the features does not reach the corresponding trigger threshold, it is returned to execute Steps 245, 250.

Step 260 includes generating a processing policy, and generating at least one action list for at least one of the roadside units 130 and the vehicles 550 based on the processing policy. Step 265 includes transmitting the at least one action list to the at least one of the roadside units 130 and the vehicles 550 through the cloud communication module 117. Specifically, the feature event can be categorized into passenger demand, fleet operation commands, traffic event alerts, and vehicle status feedback based on the features. Therefore, the public transportation managing system 100 is an intelligent public transportation global dynamic managing system, specifically an integrated public transportation global dynamic managing system based on roadside unit edge AI, cloud AI reinforcement learning, V2X communication protocol, and on-board units. The public transportation managing system 100 can achieve cross-level closed-loop collaborative control and second-level event response, as well as optimal allocation of public transportation resources and fleet operation control through real-time situational awareness, passenger demand prediction, event triggering mechanisms, and adaptive reinforcement learning algorithms, further enhancing transportation efficiency, safety, and passenger experience. In addition, the on-board units 551 can issue longitudinal and lateral control targets (e.g., acceleration/deceleration, lane change, following distance) within 1 second after receiving the policy. The public transportation fleet 500 implements Vehicle-to-Vehicle (V2V) collaborative control to stabilize inter-vehicle spacing and energy consumption, and can also feed back data to form closed-loop self-correction and adaptive policy adjustment. Furthermore, in Step 215 of the public transportation managing method 200 according to the present disclosure, the predicted situation for the roadside area 610 can be generated through the cloud server 110 based on the roadside sensing information, the vehicle sensing information, and the demand message(s) from the user(s) 700, and Steps 220, 225, 230 are subsequently executed.

In short, in the architecture of the public transportation managing system 100, the roadside units 130, the vehicles 550, and the electronic device(s) 770 of the user(s) 700 serve as a data collection layer; the cloud server 110 serves as a cloud intelligent decision-making layer; the public transportation fleet 500 and its vehicles 550 serve as an execution layer; and the V2X communication protocol layer (or extended communication layer) provides communication for the aforementioned three layers and serves as a key avoidance point. The data collection layer synchronously collects road conditions and demand information for the cloud intelligent decision-making layer. The cloud intelligent decision-making layer performs calculation and fusion to generate control strategies, and transmits the control strategies to the execution layer through the communication protocol layer.

In Steps 210, 245, based on the roadside management module 134, the roadside controller 131 can process the roadside sensing information via data anonymization for transmission to the cloud server 110. Thereby, privacy protection is enhanced.

In Steps 210, 245, based on the roadside management module 134, the roadside controller 131 can process the roadside sensing information via preliminary data aggregation for transmission to the cloud server 110. Thereby, only essential data is uploaded, reducing communication load.

In Step 250, the public transportation managing system 100 may generate the feature event through a Proximal Policy Optimization (PPO) algorithm or a Deep Q-Network (DQN) algorithm in the cloud management module 114. Thereby, the cloud management module 114 utilizes the Proximal Policy Optimization algorithm and/or the Deep Q-Network algorithm to strengthen the learning scheduling engine, and combines with cloud AI to perform passenger demand prediction, policy generation, and fleet scheduling, in order to issue instructions to the on-board units 551 through the V2X communication protocol. This enables the generation of fleet strategies based on feedback such as service punctuality rate, passenger waiting time, and safety margin, while achieving second-level policy execution and closed-loop control. Specifically, compared to the prior art, the average passenger waiting time of the public transportation managing system 100 can be reduced by more than 30%, the fleet spacing variation can be reduced by more than 30%, the travel speed can be increased by more than 25%, and the vehicle utilization rate can be increased by more than 20%.

The features may further include a plurality of vehicle scheduling features. Based on the cloud management module 114, the cloud server 110 is configured to execute Steps 280, 285 of the public transportation managing method 200. Step 280 includes generating a vehicle scheduling plan based on the feature event, and generating a plurality of driving schedules for the vehicles 550 respectively based on the vehicle scheduling plan. Step 285 includes transmitting each of the driving schedules to a corresponding vehicle 550 through the cloud communication module 117. Therefore, it helps to achieve second-level response of the vehicle scheduling plan to traffic events or passenger demand fluctuations. Furthermore, the cloud management module 114 may include a collaborative control engine to perform queue synchronization, intelligent lane changing, obstacle contingency strategies, and scheduling policy consistency checking.

In Step 250, the features further include a hotspot grid configured to determine transportation demand intensity of a plurality of stations or a plurality of road segments. In Step 280, the vehicle scheduling plan can be updated at a scheduling update time which is between 1 minute and 10 minutes. Therefore, the cloud management module 114 includes a demand prediction engine that can generate the transportation demand intensity for stations or road segments through Deep Neural Network (DNN) and Long Short-Term Memory hierarchical time-window hotspot grid rolling prediction (e.g., 5 minutes, 1 hour, 1 day, and not limited thereto).

In Step 280, based on the cloud management module 114, the cloud server 110 may be configured to: perform a risk check before the vehicle scheduling plan is generated. The risk check includes checking at least one of a stop safety and a minimum time slot, to generate the vehicle scheduling plan. Thereby, public transportation safety is enhanced.

In Step 280, based on the cloud management module 114, the cloud server 110 may be configured to: perform a contradiction and distortion check before the vehicle scheduling plan is generated. The contradiction and distortion check includes checking whether a vehicle scheduling draft satisfies at least one of a contradiction condition and a distortion condition, and when the vehicle scheduling draft satisfies at least one of the contradiction condition and the distortion condition, the generated vehicle scheduling plan is a conservative vehicle scheduling plan. Thereby, both convenience and safety are taken into account.

Regarding the public transportation managing method 200 according to the second embodiment of the present disclosure, the public transportation managing method 200 includes Steps 210, 215, 220, 225, 230. Step 210 includes obtaining a plurality of roadside sensing information of a roadside area 610 at a plurality of time points through at least one roadside sensor 138 of at least one roadside unit 130. Step 215 includes generating a predicted situation for the roadside area 610 through at least one roadside controller 131 of the at least one roadside unit 130 based on the roadside sensing information. Step 220 includes generating a priority label or a timeliness label for the predicted situation through the at least one roadside controller 131. Step 225 includes generating a broadcast message of a broadcast time point through the at least one roadside controller 131 based on the predicted situation and the priority label or the timeliness label thereof. Step 230 includes transmitting the broadcast message to a plurality of vehicles 550 at the broadcast time point through at least one roadside communication module 137 of the at least one roadside unit 130. Therefore, it helps to further achieve second-level policy execution and closed-loop control.

For further details regarding the public transportation managing method 200 according to the second embodiment, reference may be made to the content of the public transportation managing system 100 according to the first embodiment, which will not be detailed herein again.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A public transportation managing system, comprising:
a plurality of roadside units, wherein each of the roadside units comprises a roadside controller, a roadside sensor and a roadside communication module, the roadside controller, the roadside sensor and the roadside communication module of each of the roadside units are communicatively connected, each of the roadside controllers comprises a roadside processor and a roadside storage medium, and each of the roadside storage mediums is configured to store a roadside management module;
wherein based on the roadside management modules, the roadside controllers are configured to:
obtain a plurality of roadside sensing information of a roadside area at a plurality of time points through the roadside sensors;
generate a predicted situation for the roadside area through at least one of the roadside controllers based on the roadside sensing information;
generate a priority label or a timeliness label for the predicted situation through the at least one of the roadside controllers;
generate a broadcast message of a broadcast time point through the at least one of the roadside controllers based on the predicted situation and the priority label or the timeliness label thereof; and
transmit the broadcast message to a plurality of vehicles at the broadcast time point through at least one of the roadside communication modules.

2. The public transportation managing system according to claim 1, wherein the predicted situation is obtained through a Long Short-Term Memory algorithm in the at least one roadside management module of the at least one of the roadside controllers, and a time of the predicted situation is between 2 seconds and 7 seconds.

3. The public transportation managing system according to claim 1, wherein a public transportation fleet comprises the vehicles, and each of the vehicles has an autonomous driving function.

4. The public transportation managing system according to claim 3, further comprising:
a cloud server comprising a cloud processor, a cloud storage medium and a cloud communication module, wherein the cloud server is communicatively connected to the roadside units, the cloud processor, the cloud storage medium and the cloud communication module are communicatively connected, and the cloud storage medium is configured to store a cloud management module;
wherein based on the cloud management module, the cloud server is configured to:
receive the roadside sensing information, a plurality of vehicle sensing information and at least one demand message from at least one user through the cloud communication module, wherein the vehicle sensing information is obtained through a plurality of respective vehicle sensors of the vehicles at the time points;
generate a feature event based on the roadside sensing information, the vehicle sensing information and the at least one demand message, wherein the feature event comprises a plurality of features, and the features comprise a plurality of safety features;
determine whether any of the features reaches a corresponding trigger threshold;
generate a processing policy when any of the features reaches the corresponding trigger threshold, and generate at least one action list for at least one of the roadside units and the vehicles based on the processing policy; and
transmit the at least one action list to the at least one of the roadside units and the vehicles through the cloud communication module.

5. The public transportation managing system according to claim 4, wherein the feature event is generated through a Proximal Policy Optimization algorithm or a Deep Q-Network algorithm in the cloud management module.

6. The public transportation managing system according to claim 4, wherein based on the roadside management modules, the roadside controllers are configured to:
process the roadside sensing information via data anonymization for transmission to the cloud server.

7. The public transportation managing system according to claim 4, wherein based on the roadside management modules, the roadside controllers are configured to:
process the roadside sensing information via preliminary data aggregation for transmission to the cloud server.

8. The public transportation managing system according to claim 4, wherein the features further comprise a plurality of vehicle scheduling features;
wherein based on the cloud management module, the cloud server is configured to:
generate a vehicle scheduling plan based on the feature event, and generate a plurality of respective driving schedules for the vehicles based on the vehicle scheduling plan; and
transmit each of the driving schedules to a corresponding one of the vehicles through the cloud communication module.

9. The public transportation managing system according to claim 8, wherein the vehicle scheduling plan is updated at a scheduling update time, and the scheduling update time is between 1 minute and 10 minutes;
wherein the features further comprise a hotspot grid configured to determine transportation demand intensity of a plurality of stations or a plurality of road segments.

10. The public transportation managing system according to claim 8, wherein based on the cloud management module, the cloud server is configured to:
perform a risk check before the vehicle scheduling plan is generated, wherein the risk check comprises checking at least one of a stop safety and a minimum time slot, to generate the vehicle scheduling plan.

11. The public transportation managing system according to claim 8, wherein based on the cloud management module, the cloud server is configured to:
perform a contradiction and distortion check before the vehicle scheduling plan is generated, wherein the contradiction and distortion check comprises checking whether a vehicle scheduling draft satisfies at least one of a contradiction condition and a distortion condition, and when the vehicle scheduling draft satisfies the at least one of the contradiction condition and the distortion condition, the generated vehicle scheduling plan is a conservative vehicle scheduling plan.

12. A public transportation managing method, comprising:
obtaining a plurality of roadside sensing information of a roadside area at a plurality of time points through at least one roadside sensor of at least one roadside unit;
generating a predicted situation for the roadside area through at least one roadside controller of the at least one roadside unit based on the roadside sensing information;
generating a priority label or a timeliness label for the predicted situation through the at least one roadside controller;
generating a broadcast message of a broadcast time point through the at least one roadside controller based on the predicted situation and the priority label or the timeliness label thereof; and
transmitting the broadcast message to a plurality of vehicles at the broadcast time point through at least one roadside communication module of the at least one roadside unit.

13. The public transportation managing method according to claim 12, wherein a public transportation fleet comprises the vehicles, and each of the vehicles has an autonomous driving function.

14. The public transportation managing method according to claim 13, further comprising:
obtaining a plurality of vehicle sensing information at the time points through a plurality of respective vehicle sensors of the vehicles;
receiving the roadside sensing information, the vehicle sensing information and at least one demand message from at least one user through a cloud communication module of a cloud server;
generating a feature event through the cloud server based on the roadside sensing information, the vehicle sensing information and the at least one demand message, wherein the feature event comprises a plurality of features, and the features comprise a plurality of safety features;
determining whether any of the features reaches a corresponding trigger threshold through the cloud server;
generating a processing policy through the cloud server when any of the features reaches the corresponding trigger threshold, and generating at least one action list for at least one of the at least one roadside unit and one of the vehicles based on the processing policy; and
transmitting the at least one action list to the at least one of the at least one roadside unit and the one of the vehicles through the cloud communication module.

15. The public transportation managing method according to claim 14, wherein the features further comprise a plurality of vehicle scheduling features, and the public transportation managing method further comprises:
through the cloud server, generating a vehicle scheduling plan based on the feature event, and generating a plurality of respective driving schedules for the vehicles based on the vehicle scheduling plan; and
transmitting each of the driving schedules to a corresponding one of the vehicles through the cloud communication module.
